(19) United States
(12) Patent Application Publication
(10) Pub. No.: US 2008/0135484 A1
(43) Pub. Date: Jun. 12, 2008

(54) Liquid Chromatography Apparatus

(76) Inventor: Michael R. Hammer, Victoria (AU)

Correspondence Address: Varian Inc.;Legal Department, 3120 Hansen Way D-102, Palo Alto, CA, 94304, US

(21) Appl. No.: 11/665,141

(22) PCT Filed: Oct. 18, 2005
(86) PCT No.: PCT/AU2005/001607

§ 371 Date: Apr. 11, 2007

(30) Foreign Application Priority Data
Oct. 18, 2004 (AU) 2004906027
Oct. 18, 2004 (AU) 2004906028
Oct. 18, 2004 (AU) 2004906029
Oct. 18, 2004 (AU) 2004906030

(51) Int. Cl. B01D 15/08

(52) U.S. Cl. 210/656; 210/198.3

(57) ABSTRACT

A multi-column liquid chromatography system (10) for performing a plurality of liquid chromatography separations in parallel is based on a column plate structure (12) having parallel grooves (20) formed in a surface (22) of a plate (18), a cover sheet (40) bonded to the surface (22) to cover the grooves (20) and a stationary phase (38) contained in each covered groove (20). Through holes (24, 26) in the plate (18) define respective inlets (24) for the chromatography columns (14) and flow cells (16) at outlets, with the cover sheet (40) providing an optically transparent end wall for the flow cells (16) and another cover sheet (42) bonded to the opposite surface (30) of the plate (18) providing the other optically transparent end wall for the flow cells (16). Thus merely three parts need be provided for a structure for providing the chromatography columns, that is, a plate having grooves and through holes plus two cover sheets. The chromatography system (10) additionally includes a pumping system (46) comprising a syringe pump (48) for each column (14), an optical system (28) for transmitting analytical radiation through the flow cells (16) and a fraction collection sheet (110) containing wells (112) which is fed past outlets (34-35) from the column plate structure (12).

### TECHNICAL FIELD

The present invention relates to liquid chromatography and in particular to multi-column liquid chromatography apparatus for performing a plurality of liquid chromatography separations in parallel. The invention also relates to various components for providing a multi-column liquid chromatography system.

### BACKGROUND

The discussion herein of the background to the invention and the prior art is included to explain the context of the invention. This is not to be taken as an admission that any of the material referred to was, in Australia, published, known or part of the common general knowledge in the art as at the priority date of the claims.

Liquid chromatography is a physical separation method wherein liquid solvent (that is, “a mobile phase”) carries a sample mixture through a separation medium (that is, “a stationary phase” contained in a column) for the sample to be separated into its different constituents due to each constituent of the sample interacting differently with the stationary phase. An example is High Performance Liquid Chromatography (HPLC) (often used for separations involving biological samples) which is typically performed at high operating pressures, for example up to possibly about 100 megapascals.

Known apparatus for liquid chromatography separations typically involves a separation column and various other separate components/modules that are interfaced with each other via high pressure connections and fittings. Such apparatus is complex and tends to be difficult to operate, moreover it is relatively slow, for example a typical separation and analysis time could take several minutes, which is quite inefficient when there are many samples for analysis.

The above problems together with a bias towards conducting analyses with smaller sample volumes, have led to recent proposals wherein multiple chromatographic separations are performed simultaneously in parallel. A current commercial system provides twelve “microfluidic columns” (that is, one dimension is less than 500 microns) in a multilayer structure. The multilayer microtechnology structure is relatively large (about A4 size) and is complex, being made up of many plastic layers bonded together. These layers need to be accurately aligned before the bonding step. The system also involves complex connection and valving arrangements between a single pump and the columns in the multilayer structure, between sampling means and the columns, and between the columns and output flow cells for optical detection means. This complexity is highlighted by a system cost of about ten times the cost of a conventional liquid chromatography system.

The present invention seeks to provide a multi-column liquid chromatography system, and various components therefor, for performing a plurality of separations in parallel that is less complex than the above mentioned “microfluidic” system.

### DISCLOSURE OF THE INVENTION

According to the present invention there is provided multi-column liquid chromatography apparatus including
a column plate structure that provides a plurality of liquid chromatography columns for performing a plurality of chromatography separations in parallel, the column plate structure including a plate having grooves formed in a surface and a cover sheet bonded to that surface to cover the grooves,
wherein a stationary phase for each liquid chromatography column is contained in each covered groove.

Preferably the column plate structure also provides a flow cell at an outlet of each chromatography column.

Preferably the apparatus also includes a pumping system for simultaneously supplying a sample or a mobile phase into an inlet, respectively, of each chromatography column.

Preferably the apparatus also includes an optical system for transmitting radiation through each flow cell and including a detection arrangement for detecting radiation from each flow cell.

The apparatus together with the pumping system and the optical system provides a multi-column liquid chromatography system.

Preferably the chromatography apparatus includes a pair of presser plates for receiving therebetween the column plate structure, wherein during a chromatography separation, the presser plates apply pressure to the column plate structure for the liquid chromatography columns to remain intact under pressures applied by the pumping system. This preferred feature of presser plates is required where a cover sheet of the column plate structure is not rigid, for example when it is a membrane, as will be described in detail below.

Preferably the optical system is for transmitting essentially monochromatic radiation through each flow cell.

The present invention also provides a plate for a multi-column structure for liquid chromatography, the plate having a plurality of first grooves in a surface thereof for each first groove to form a column for liquid chromatography when a cover sheet is bonded to the surface of the plate over the first grooves and each first groove is filled with a stationary phase,
the plate including through holes each associated with one end of each first groove to provide an inlet into each chromatography column, the plate furthermore including, at the other end of each first groove, a second groove leading from the first groove to provide an outlet path from each chromatography column, wherein the second grooves are smaller in cross-sectional size than the first grooves.

Preferably the plate for the column plate structure is a moulded plate that has a plurality of parallel first grooves in a surface thereof and has through holes associated with each first and second groove for providing respectively an inlet and an outlet for each chromatography column. A smaller second groove leads from one end of each first (column) groove to the outlet through hole to provide a size transition volume for a porous barrier to be formed for retaining a stationary phase, as will be described below. In this preferred plate, the flow cell for each chromatography column may be provided by the “outlet” through hole associated with each second groove. An outlet from each flow cell may be provided by an additional groove in the opposite surface of the moulded plate that connects to a further through hole.

The size transition volume from the larger first groove to the smaller second groove for each chromatography column allows for the establishment of a porous mass of particles at the transition for retaining a stationary phase in the first groove whilst allowing passage of a mobile phase, thus the porous mass of particles acts as a “frit” as in conventional chromatography columns. This porous mass of particles may be formed by pumping in a small amount of particles with a size comparable to or larger than the size of the outlet path, as will be described below. These particles wedge into the transition from the larger first groove to the smaller second groove and when packed together form a porous barrier, which allows passage of liquid but blocks passage of the stationary phase. These particles are either chromatographically inert or may have the same composition as the rest of the column packing material, that is, the stationary phase material. Such mass of particles forming a barrier for the stationary phase is hereinafter termed a “frit mass”.

To form the chromatography columns, a cover sheet is bonded to the surface of the moulded plate such that the larger first and smaller second grooves and their through holes are covered. A frit mass is then established in each first groove at the transition between the larger and smaller groove and each first groove is then filled, from its entry end up to the stationary phase retaining frit mass, with a stationary phase medium. For example, a small amount of a slurry of large particles (for forming a frit mass) can be pumped into each first groove through each inlet hole followed by a slurry of the desired stationary phase medium. The liquid component of this slurry flows out of the grooves through the frit masses so formed and the outlet second grooves leaving the solid component packed into the first grooves behind the frit masses, and this forms the stationary phase.

Another sheet can be bonded to the opposite surface of the plate to provide an end wall for each flow cell and define the outlet passageway for each flow cell via the further groove and further through hole. The cover sheets need to be transparent to the optical detection wavelengths employed, which may be as low as 210 nm, at least in the regions of the flow cells.

Thus the column plate structure for the multi-column liquid chromatography apparatus is preferably provided by a moulded plate, which with a cover sheet defines a plurality of columns at one surface of the moulded plate, with each column having an inlet provided by a through hole that is open at the opposite surface of the moulded plate and a flow cell at a column outlet that is provided by another through hole, the end walls of which are provided by the cover sheet and another cover sheet, respectively. That is, merely three parts need be provided for realisation of a structure for the plurality of chromatography columns, namely the plate having grooves and through holes (which is preferably a moulded plate) plus two cover sheets (which may be simple plastic foils or membranes without any surface details).

The column plate structure of this invention, being based upon a component that is formed as an integral unit (preferably a moulded plate), allows for a relatively less complex manufacture of the plurality of chromatography separation columns compared to the above described prior art, and also for a less complex assembly and operation of the multi-column chromatography system as a whole, as will be described below. The moulded plate also allows for relatively easy provision of a flow cell (via a through hole) for each chromatography separation column that has a fixed optical path length (defined by the thickness of the moulded plate) for allowing stable qualitative analysis results to be achieved. The optical path length (that is, thickness of the plate) can be readily defined at the design stage by the dimensions of an injection moulding die, and the thickness dimension is maintained very consistently during the moulding process. Plates with different optical detection path lengths are readily achievable by use of different dies. In principle it is also possible to use a flow path that directs the liquid flow repeatedly up and down through the thickness of the plate through a multiplicity of holes, and by changing the plate thickness at each hole location a multiplicity of flow cells for each column, with different path lengths for each flow cell, may be provided. In practice such an extension would have the advantage of extending the dynamic range of the optical detection means.

The present invention also extends to a plate as described above, which is preferably moulded, having the above mentioned cover sheets bonded to its surfaces and furthermore to the plate and cover sheets assembly having a stationary phase material in the first grooves, thereby providing a multi-column structure as such for liquid chromatography analyses to be conducted in parallel in a multi-column liquid chromatography system.

Liquid chromatography typically involves high pressures within the chromatography columns and in embodiments where the bonded cover sheet of the column plate may not be rigid enough to withstand these pressures, the possible problem of distortion or rupture of the cover sheet can be avoided by clamping the column plate structure tightly between two rigid back-up plates (herein termed “presser plates”) during operation. These presser plates may form part of the non-disposable portion of an instrument in which the chromatography separations are performed. Preferably the instrument is arranged such that a particular operator action (such as loading the column plate structure into the instrument or closing the door of a sample compartment of the instrument after inserting the column plate structure) automatically engages the presser plates for clamping the column plate structure (hereinafter termed a “column plate”) therebetween.

The presser plate that is adjacent the bonded cover sheet surface on the column side of the column plate may be connected to a controllable heater or cooler, for example based on Peltier effect devices, for controlling the temperature of the chromatography columns during a separation. Thus it is possible to control the temperature of the chromatography columns both fast enough and accurately enough to allow accurate and repeatable thermal gradients to be established during each analysis. This is possible because the separation between the chromatography columns and the heated or cooled presser plate is the thickness of the bonded cover sheet, which if it is a membrane may be about 100 microns, and the depth of the columns, which may be about 1 mm. This gives a very short thermal lag from the presser plate to the chromatography columns. Such dynamic control of the column temperature during an analysis is generally not possible in a conventional chromatography column because of the thickness of the walls and distance to the centre of the column, even though in conventional columns it is possible to maintain a constant and stable temperature within the stationary phase material during operation. Thus this feature, for example, makes it possible to create a temperature ramp from a defined initial temperature at a defined temperature change in degrees per minute during each analysis. The ability to create such a temperature ramp or gradient (which is akin to a solvent gradient approach that is presently used in chromatography) gives an advantage over a conventional chromatography column, for example increased versatility.

Preferably the pumping system includes a plurality of syringe pumps, one for each chromatography column, and a control mechanism that is common to the plurality of syringe pumps for the pumps to provide a substantially identical positive displacement flow of the mobile phase through each column. This provides an advantage in that the flow rate of the mobile phase can be maintained constant for each column irrespective of the pressure drop required for that flow rate. In contrast, in the above described current commercial system, a single pump is used with flow splitters to each column resulting in a substantially constant pressure drop across each column. Since retention time depends upon flow rate, not pressure drop, the preferred pumping system of the present invention is more desirable because it ensures a constant flow rate for each column.

Thus, the invention also provides a pump arrangement for a multi-column liquid chromatography system including
a plurality of syringe pumps, one for each column of a multi-column liquid chromatography apparatus for supplying a sample and a mobile phase into an inlet of each column and for flowing the sample and the mobile phase through the column, wherein the plurality of syringe pumps have a common controller for simultaneously operating the plurality of syringe pumps to provide a substantially identical positive displacement flow through each column.

An example structure for the syringe pumps is the provision of a single syringe block containing a plurality of bores, each bore containing a piston and the plurality of pistons connected by a common gantry. Alternatively a plurality of identical syringes could be provided that are suitably fixedly mounted together, with their individual pistons mechanically coupled such that they operate identically together. The gantry or mechanical coupling can be driven by a single motor, for example a stepper motor, or other drive mechanism as would be known by persons who are skilled in the art.

The provision of a pumping system based on syringe pumps also reduces complexity compared to the prior art in that it allows for deletion of all valving associated with handling the sampling and mobile phase, and use of the syringe pumps as the sampling means. Thus, preferably, each syringe pump has a pump tube having a free end, and the free ends of the pump tubes are held in a single block (hereinafter “clamp block”) at a spacing corresponding to the spacing of the chromatography columns on the column plate. Each syringe pump tube is sealable to its respective column by a seal around the end of each syringe pump tube (which may be an O-ring seal). Pressure, in a direction normal to the column plate, is applied to the clamp block holding the syringe pump tubes and clamps all syringe pump tubes to their respective columns. The sealed connection between the syringe pump tubes and their respective chromatography columns on the column plate can be opened by lifting the clamp block.

According to a preferred mode of operation, at the end of each analysis cycle (involving the analysis of one sample on each parallel column) the above-mentioned sealed connection is opened and the clamp block is positioned over a reservoir of mobile phase such that the free ends of the syringe pump tubes are below the liquid level in this reservoir. The syringe pistons are then driven backwards so as to draw mobile phase into the syringes. Once the required amount of mobile phase has been collected, the free ends of the syringe pump tubes are moved to the sample vessels and the pistons driven further backwards so as to collect a known and precise amount of sample into the end of each syringe pump tube. The syringe pump tubes are then moved and resealed to the column plate via the seal around each syringe pump tube. Driving the syringe pistons forwards injects first the sample followed by the mobile phase.

Preferably, samples for the chromatography system are presented in well plates. Well plates are commonly used for sample presentation and provide a known and fixed spacing between adjacent samples. Preferably the chromatography column spacing on the column plate match the well spacing on a well plate so that the syringe pump tubes align with both the samples and the columns.

The above description exemplifies a further aspect of the invention. According to this further aspect, the invention provides a method for liquid chromatography including
providing a plurality of liquid chromatography columns,
providing a syringe pump for each column, each syringe pump having a pump tube having an open end,
simultaneously placing the open ends of the pump tubes into a mobile phase reservoir,
simultaneously operating the syringe pumps to draw a volume of the mobile phase into each pump tube,
withdrawing the pump tubes from the mobile phase reservoir and then simultaneously placing each open end of each pump tube into a respective sample reservoir,
simultaneously operating the syringe pumps to draw a volume of sample into each pump tube,
withdrawing the pump tubes from the sample reservoirs and then simultaneously applying each open end of each pump tube to a respective inlet of each chromatography column, and
simultaneously operating the syringe pumps to pump the sample and mobile phase from each syringe pump through each respective chromatography column.

The provision and use of syringe pumps as above described allows the establishment of substantially identical positive displacement flow for each chromatography column, as is required for accurate, repeatable liquid chromatography analyses.

In many liquid chromatography applications, the analysis requires that the composition of the mobile phase vary during the analysis in a controlled pre-determined way. Typically, the mobile phase is made up of a mixture of two or more solvents and the relative proportions of each component is changed during the analysis. This provides a solvent gradient over time. Such a solvent gradient can be established in a system according to the invention by the use of a plurality of syringe modules with the corresponding pump tubes connected together, usually via a mixing arrangement and preferably in the clamp block, to provide a single open end for sealing connection to each chromatography column. Syringes in each syringe module are filled with a different mobile phase component and the gradient is established by varying the relative rates of drive to the syringe modules progressively during each analysis, that is, the syringe pump modules are differentially operated.

The optical system may take various configurations to direct selected appropriate radiation through each flow cell and detect radiation from each flow cell. A simple configuration is for a light source for each flow cell to be located on one side of the flow cell and a detector on the other side. Preferably the optical system is such as to derive a beam of substantially monochromatic light of selected wavelength and direct this through the flow cells, either in turn on a cyclic sequential basis, or by splitting it into multiple light beams and directing each through a flow cell on a simultaneous parallel basis. Thus the optical system may include optical fibres for directing radiation from a single light source and monochromator into each flow cell. The detection arrangement may consist of individual light detectors, for example photodiodes, positioned close to and in line with each flow cell.

In many liquid chromatography applications one or more portions of the output of the separation column are collected during an analysis so as to collect one or a group of constituents (that is, “fractions”) of the original sample which have been separated by passage through the column. Conventionally this is done by connecting a tube to the outlet of the flow cell and the provision of a mechanical movement mechanism to position the tube outlet over collection receptacles, typically well plates, in a defined time sequence or in response to the detection of a “peak”. In the present invention involving parallel analyses using a multi-column chromatography apparatus, the conventional method would be too complex to implement and in any case the number of conventional well plates required would be impractical.

Thus the present invention also provides a sample fraction collection sheet for liquid chromatography comprising
a flexible plastic sheet of indefinite length having wells formed therein for collection of sample fractions,
wherein the flexibility of the sheet is such that it is storable on a roll for feeding therefrom past a liquid chromatography fraction collection location.

The invention furthermore provides a method for forming a sample fraction collection sheet for liquid chromatography of indefinite length, the method including
heating a plastic sheet and passing the heated plastic sheet between two rolls, the rolls including protrusions for deforming the sheet to form rows and columns of wells, each well for collecting a fraction of a sample from a liquid chromatography column.

As part of a multi-column liquid chromatography system according to an embodiment of the invention, there may be provided a sample fraction collection sheet having rows of wells formed therein, each row of wells extending across a width of the sheet and the wells also forming columns along the length of the sheet, wherein the sheet is preferably flexible whereby a substantial length of the sheet is storable on a roll for feeding past flow cell outlets of the chromatography apparatus. Alternatively the sheet may be substantially rigid, similar to a well plate.

Preferably the fraction collection sheet is formed by deforming a thin inert plastic sheet through heat and pressure so as to form the rows and columns of indentations or wells. A wide variety of plastic materials may be used, for example 300 micron thick polypropylene sheet. The spacing between the columns of wells can match the spacing of the outlets from the flow cells, which may be the same as the chromatography column spacing of the column plate. The spacing between individual indentations or wells within each column (that is, the spacing between the rows) depends on the desired volume of each well but a spacing between about 3 and 9 mm may be considered typical. By providing effectively a “continuous” strip of fraction collection sheet, an operator of the multi-column chromatography system can process many samples without having to replace fraction collection well plates or having to resort to complex mechanical means for changing and stacking such plates.

In order to ensure efficient delivery of fractions from the outlets of the flow cells, the column plate may be formed with a protuberance concentrically surrounding each of the above described further through holes of the column plate, which further through holes together with said further grooves define said outlet passageways of the flow cells. The protuberances are such as to effectively define hollow nipples or needles on, in use, the bottom surface of the column plate for delivery of the fractions directly into the wells of the fraction collection sheet.

In operation, a flexible sample fraction collection sheet can be driven from a storage roll past the flow cell outlet nipples by a driven drum having indentations in its surface that match the wells in the sheet (that is, whereby the wells seat within the indentations of the drum). This drum can be positioned so that a row of wells within the indentations of the drum will be located directly below the row of nipples on the bottom surface of the column plate with the sheet as close to the nipples as possible, for example typically less than 1 mm and preferably less than 0.25 mm. This is to ensure that any droplets formed through surface tension on the end of the nipples are wiped off when moving from one well to the next. The problem of droplet formation on the end of the nipples may be further alleviated by making the end of the nipple sloped instead of parallel to the bottom face of the column plate (similar to the way in which a hypodermic needle is sharpened). The drum can typically be driven in a discontinuous fashion, for example by a stepper motor. The drum advances from one well to the next according to the predetermined time sequence or in response to “peaks” detected as separated components of the sample that emerge from the columns. This system does not allow differential timing between the multiplicity of chromatography columns but such capability is not generally required by the anticipated users of a system according to the invention.

The possibility that the collection of a very long time fraction could exceed the well capacity can be overcome by making the driven drum heated so that the mobile phase is evaporated as it is being collected, leaving just the dried sample component remaining. This also facilitates storage of the fractions that are collected. The samples can be re-solvated as required.

The fraction collection sheet may be made with documentation tracks on each side. Registration and sample identification information may be printed on these tracks as the sample fractions are collected by appropriately positioned print heads.

If more permanent sealing of the collected fractions is required, such as to prevent contamination in very sensitive applications, a second sheet carrying suitable adhesive means on its underside (such as an inert pressure sensitive adhesive) may be automatically laminated onto the fraction collection sheet as it emerges from the driven drum.

For a better understanding of the multi-column liquid chromatography apparatus and its components as such of the invention and to show how the same may be performed, preferred embodiments thereof will now be described, by way of non-limiting example only, with reference to the accompanying drawings. In accordance with common practice in patent descriptions, the various features of the drawings are not to scale. That is, the dimensions of the various features are arbitrarily expanded or reduced for clarity.

### BRIEF DESCRIPTION OF DRAWINGS

FIG. 1 is a schematic, generally cross-sectional, view of a multi-column liquid chromatography system according to a preferred embodiment of the invention (the generally cross-sectional view is along a chromatography column and thus only one column is illustrated).

FIG. 2 is an isometric view of a moulded plate for making a column plate of the system of FIG. 1.

FIG. 3 is a cross-sectional view of a column plate for use in the system of FIG. 1.

FIG. 3A is similar to FIG. 3 but shows a modification for the moulded plate.

FIG. 4 is a schematic view of a pumping system for use in the system of FIG. 1.

FIG. 4A illustrates a pump arrangement embodiment for the invention.

FIG. 5 is a schematic cross-sectional view of portion of the system according to FIG. 1, illustrating connection of a pump tube to a column plate.

FIG. 6 is a schematic cross-sectional view of portion of the system of FIG. 1 illustrating the column plate in use.

FIG. 7 is a schematic view illustrating the layout of various components of the system of FIG. 1.

FIG. 8 schematically illustrates portion of an optical system of the system of FIG. 1.

FIG. 9 schematically illustrates a method for forming a fraction collection sheet for the system of FIG. 1.

### DESCRIPTION OF EMBODIMENTS

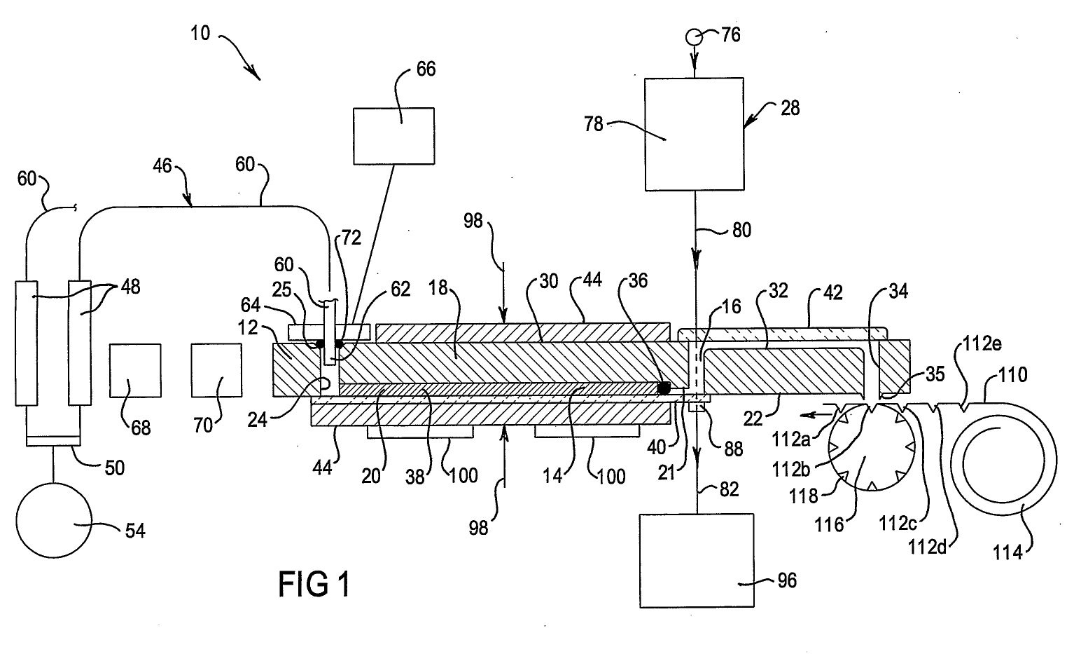

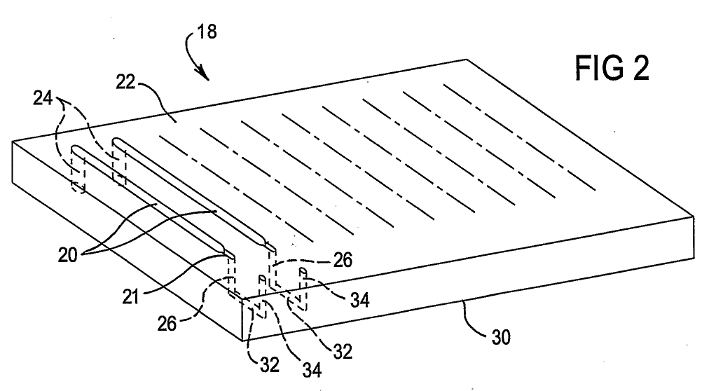

With reference to FIG. 1, a multi-column liquid chromatography system 10 according to an embodiment of the invention includes a column plate 12 that incorporates a plurality, for example twelve or twenty four, of liquid chromatography columns 14 (only one of which is shown in the FIG. 1 schematic cross-section) for performing a plurality of liquid chromatography separations in parallel. The column plate 12 also includes a flow cell 16 at an outlet of each column 14. The column plate 12 is made from a moulded plate 18 (see FIG. 2), that includes parallel first grooves 20 in a surface 22 thereof which are for forming the chromatography separation columns 14. A smaller cross-sectioned second groove 21 leads from each groove 20 for providing an outlet path from each chromatography column 14. The moulded plate 18 also includes through holes 24, each associated with one end of a respective first groove 20, for providing an inlet for each chromatography column 14. Further through holes 26, each associated with the other end of a smaller second groove 21 leading from a respective first groove 20, are for providing the flow cells 16 for an optical system 28 for analysing the results of separations by the chromatography columns 14. In a surface 30 opposite to the surface 22 of the moulded plate 18, additional grooves 32 are formed, each extending from a respective through hole 26, and additional through holes 34 are also provided, each associated with a respective additional groove 32. The additional grooves 32 and additional through holes 34 are for providing an outlet passage way for each flow cell 16.

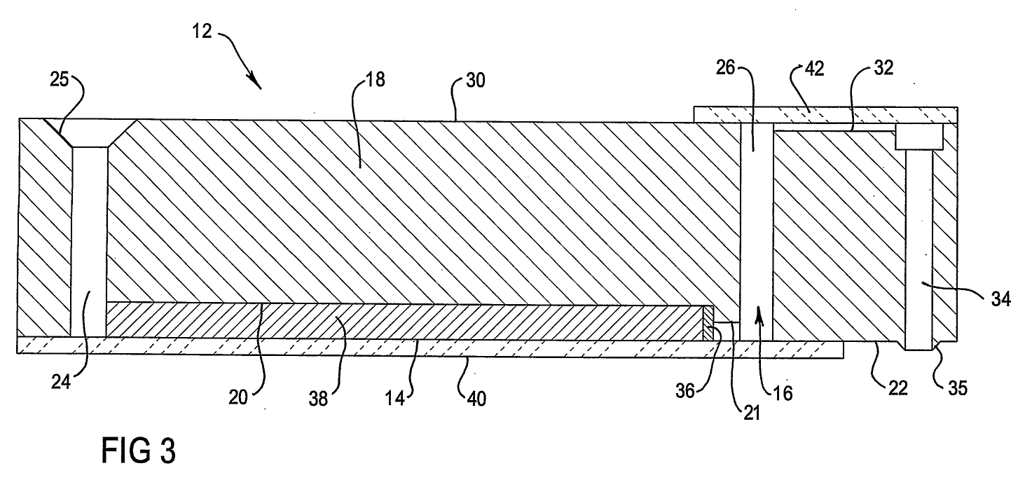

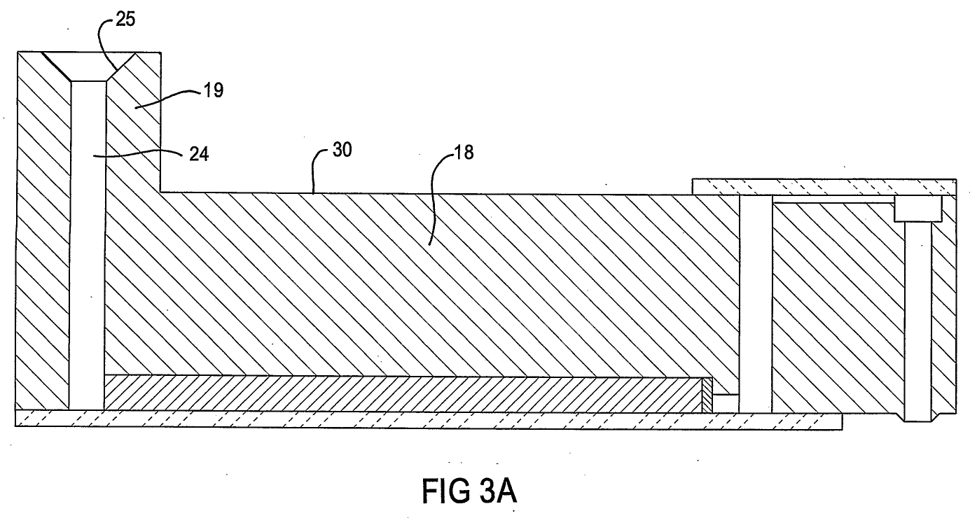

The column plate 12 is formed by bonding a cover sheet 40 to the surface 22 of the moulded plate 18 to cover the grooves 20 and 21. A small amount of a slurry of large particles is first pumped into each covered first groove 20 through each inlet hole 24 to form a frit mass 36 at the transition from each larger first groove 20 to each smaller second groove 21 (the second grooves 21 are smaller in cross-sectional size than the first grooves 20), and this is followed by a slurry of a stationary phase medium 38. The liquid component of this slurry flows out of the first grooves 20 through the stationary phase retaining frit masses 36 and the outlet passageways leaving the solid component packed into the first grooves 20 behind the stationary phase retaining frit masses 36, and this forms the stationary phase 38. (see FIG. 3). Thus a plurality of chromatography separation columns 14 are formed between the first grooves 20 in the moulded plate 18 and the bonded cover sheet 40. The cover sheet 40 also extends over the through holes 26 to provide an end wall for the flow cells 16. Another cover sheet 42 is bonded to the opposite surface 30 of moulded plate 18 to cover the additional grooves 32 and the through holes 26 and 34. The cover sheet 42 provides an end wall for the flow cells 16 and completes an outlet passageway of each flow cell 16 via groove 32 and through hole 34.

The cover sheets 40 and 42 are preferably sealable membranes and transparent to the optical detection radiation wavelengths, typically below 300 nm and possibly down to 210 nm. The materials of the moulded plate 18 and cover sheets 40 and 42 must also be sufficiently chemically inert and able to be bonded together so that no leaks develop. Preferably the plate 18 is moulded from cyclic olefin copolymer (COC), for example the plastic material classified as 8007X10 manufactured by Triconex in Germany. Fillers may be added to this plastic material prior to or during the moulding process to improve the dimensional stability of the moulded plate 18 and to render it opaque to light, which makes detection of the light passing through the flow cells 16 easier to isolate and detect. Such fillers need to be inert to the samples and mobile phases used in chromatographic analyses. The cover sheets 40 and 42 are each a COC membrane (preferably of the 8007X10 grade which is the most optically transparent grade presently available) and are thermally fused to the moulded plate 18. The COC material in membrane form (typically around 100 micron thick) is transparent down to about 210 nm. COC also has the required chemical inertness and is suitable for thermal bonding without the use of an adhesive layer.

The inlet through holes 24 for the chromatography columns 14 are each formed with a widened conical entrance 25 for a purpose to be described below. The moulded plate 18 is also formed with a protuberance 35 concentrically around each respective outlet through hole 34. The protuberances 35 effectively provide nipples for delivery of fractions from the flow cells 16 into a collection sheet, as will be described in greater detail below.

With reference to FIG. 3A, the moulding of the plate 18 may be modified to provide an extension 19 on its surface 30 through which each inlet hole 24 is extended to thereby raise the conical entrances 25 for a purpose to be described below.

With reference again to FIG. 1, the multi-column liquid chromatography system 10 includes a pair of rigid presser plates 44 for receiving therebetween the column plate 12, further description of which will be provided below.

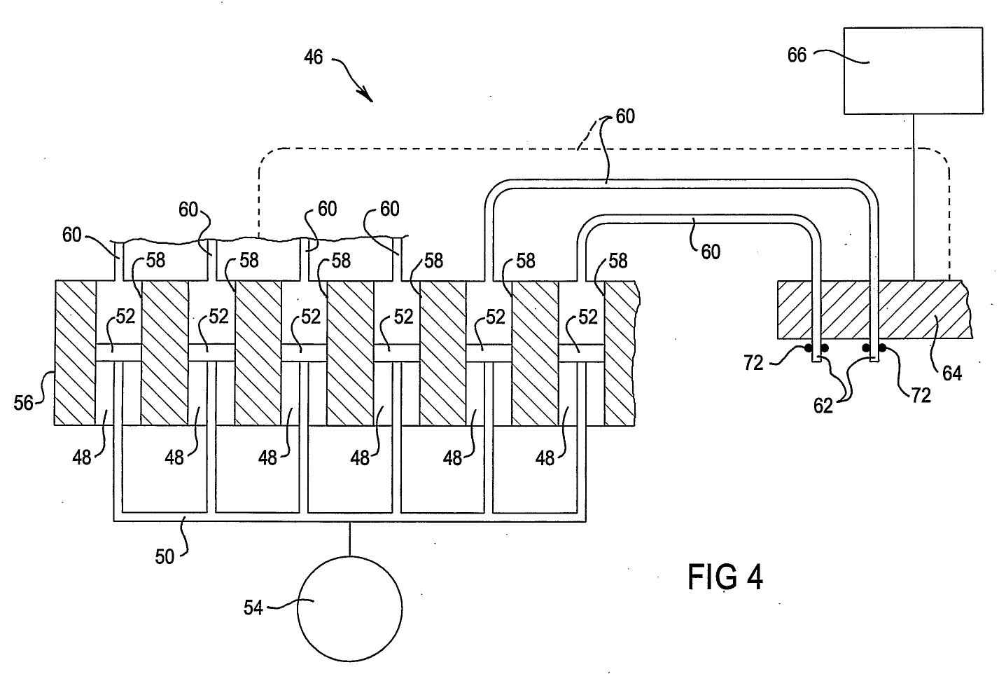

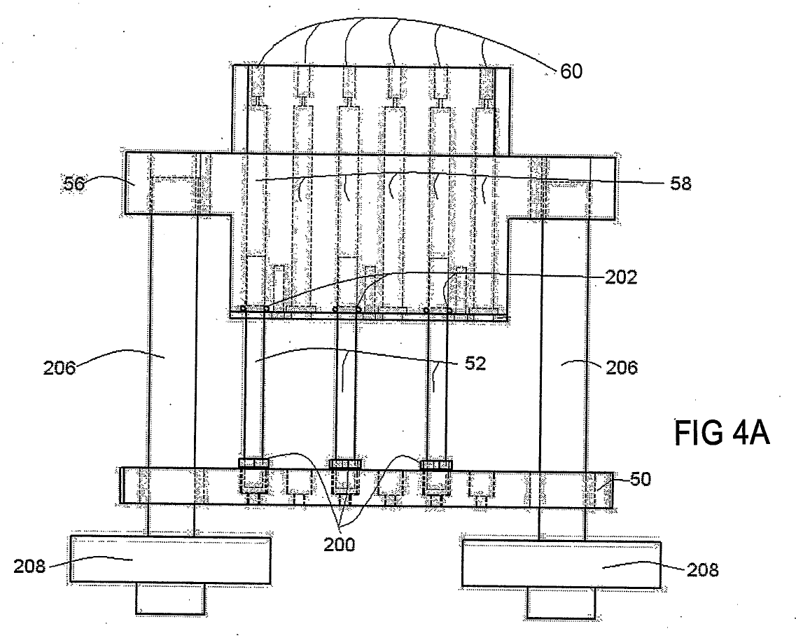

The multi-column liquid chromatography system 10 also includes a pumping system 46 for simultaneously supplying a sample and/or mobile phase into the inlet hole 24 of each respective chromatography column 14. With reference to FIG. 4, the pumping system 46 includes a plurality of syringe pumps 48, one for each chromatography column 14, and a control mechanism that is common to all of the syringe pumps 48. The control mechanism includes a gantry 50 that connects all of the pistons 52 of the pumps 48 together and a stepper motor 54 for driving the gantry 50, and thus all of the pistons 52 simultaneously. As shown by FIG. 4, the plurality of syringe pumps 48 may be provided via a single syringe block 56 containing a plurality of bores 58, each containing a piston 52.

A pump module for the current structure requires a capacity of about 1.5 ml per channel with twelve or twenty four channels per module. It is also necessary to ensure that sufficient control is available to allow accurate collection of small sample quantities of the order 1-5 microlitres and that smooth pulseless flow is achievable down to about 10-20 microlitres per minute. These requirements set constraints on practical piston diameters and stroke lengths. In practice, a piston diameter of 5-7 mm with a corresponding stroke length of 75 mm to 36 mm for 1.5 ml capacity has proved to be convenient.

It is important that the materials used for the pump are inert and in the case of some biological samples this means that all common construction metals must be excluded. For this reason the pump body has been constructed using an inert plastic. Many suitable plastics are available for example a polyolefin (such as polypropylene or polyethylene), or a polyester (such as polyethylene terephthalate) or perfluorinated polyolefin (such as polytetrafluoroethylene). Several other plastics many also be suitable and the choice typically will also take into account the machinability of the particular plastic with the available machining facilities. With reference to FIG. 4A the pistons 52 (three of twelve are shown) are made of glass rod or sapphire rod. Such materials are very inert and also offer a very smooth surface finish ideal for forming the sliding surface of the pressure seal. In practice each piston 52 only contacts a sealing element 202 (which can be an O-ring or a plastic piston seal or any other suitable structure) and has clearance to the syringe bore 58 (six of twelve are shown in FIG. 4A). Since the gap between the piston 52 and the bore 58 is entirely filled with mobile phase which is incompressible the dead volume resulting from this clearance is of no consequence.

It is important to ensure that the gantry 50 to which the pistons 52 are attached by piston holders 200 (three of twelve are shown in FIG. 4A) moves perpendicularly to the axis of the syringe bores 58. Any rock or tilt in the gantry 50 as it is moving will cause one syringe to discharge more than another syringe and this is not acceptable analytically. To ensure that the motion remains accurately perpendicular to the syringe bore 58 axes, the gantry 50 is driven by two lead screws 206 positioned at each end of the gantry 50. Lead screws offer a positive displacement drive and the two lead screws 206 are phase locked together so that they both rotate through an identical angle for any given motion. Because the force on these lead screws 206 is very substantial at the pumping pressures required, achieving low enough friction and hence efficiency of these lead screws 206 is of concern. For this reason the preferred lead screws 206 are ball screws. The two lead screws 206 may be conveniently locked together by running both from a pulley 208 driven by a single timing belt (not shown) which in turn is driven by the drive motor (not shown). This arrangement makes a ratio change between motor and lead screws 206 easy to achieve by appropriate selection of diameters of pulleys 208. The two pulleys 208 on the two lead screws 206 must of course have the same number of teeth so as to maintain identical rates of rotation but the motor may have a different number of teeth allowing a step up or step down ratio to be achieved. In the current embodiment the two lead screws use 40-tooth pulleys while the motor uses a 10-tooth pulley achieving a 4:1 step down ratio between motor and lead screws.

Any other dual drive mechanism offering positive displacement motion would also be adequate. For example, a dual rack and pinion drive with the two racks attached to the gantry and the two pinions forced to rotate in synchronism such as would be achieved by mounting both onto a single drive shaft driven in turn by the motor. In practice, ball screw 206 has the additional advantage of offering a small linear motion per revolution (5 mm on our case) thus achieving mechanical reduction which increases fluid dispensing resolution and acts to multiply the torque from the motor allowing the use of a lower torque motor.

The motor can conveniently be a stepper motor. This allows a very high degree of mechanical precision in an open loop system—eliminating the need for position feedback means other than a single end stop.

Each syringe pump 48 has a pump tube 60 having a free end 62 for insertion into the inlet hole 24 of a chromatography column 14 (only two of the free ends 62 are illustratively shown in FIG. 4). The pump tubes 60, adjacent their free ends 62, are held in a clamp block 64 at a spacing corresponding to the spacing of the chromatography columns 14 and their inlet holes 24 in the column plate 12. A sampler controller 66 is linked to the clamp block 64 so as to move it, and thereby the free ends 62, to desired locations for each of the syringe pumps 48 simultaneously to draw in, via operation of stepper motor 54, a volume of the mobile phase from a reservoir 68 (see FIG. 1) and then for a volume of a respective sample from sample reservoirs 70 (only one of which is illustratively shown in FIG. 1) to be drawn into the end 62 of each syringe pump tube 60. Thus the sample does not mix with the mobile phase and remains in the pump tube end 62 to be injected as a slug of sample, that is, the pump tube end 62 has such a small bore that there is no mixing, allowing the sample to be injected as an undiluted slug at the start of the analysis. The sampler controller 66 is then operated to move the clamp block 64 to insert the free ends 62 of pump tubes 60 into the inlet holes 24 of chromatography columns 14.

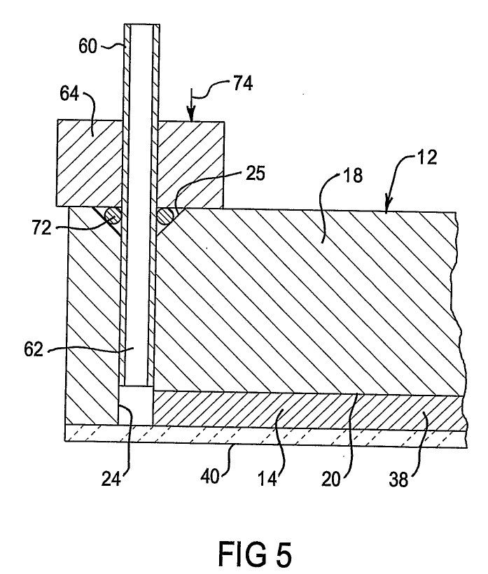

Each free end 62 of each pump tube 60 carries an O-ring 72. With reference to FIG. 5, when the clamp block 64 is moved to insert the free ends 62 of pump tubes 60 into the inlet holes 24 of chromatography columns 14 and pressure applied to the clamp block 64 in a direction normal to the column plate 12 (as indicated by arrow 74), the O-rings 72 engage the respective conical entrances 25 to seal all of the syringe pump tubes 60 to the inlets 24 of their respective chromatography columns 14. The conical entrances 25 also serve to guide the free ends 62 of the pump tubes 60 into the inlet holes 24. At the conclusion of an analysis cycle (involving the analysis of respective samples on each parallel column 14), the sealing connections between the syringe pump tube 60 and their respective columns 14 are opened by operating the sampler controller 66 to lift the clamp block 64.

The modified multi-column plate of FIG. 3A is for applications where relatively long pump tube ends 62 are required for them to reach down into sample reservoirs 70 to collect the samples. The extension or extensions 19 on surface 30 of plate 18 through which each inlet hole 24 is extended to raise the conical entrances 25 accommodate and guide the extra length of the pump tube ends 62.

With reference again to FIG. 1, the multi-column liquid chromatography system 10 also includes an optical system 28 for simultaneously transmitting monochromatic radiation through each flow cell 16 for analysing sample fractions as they flow through the flow cells 16, which system 28 includes appropriate detection componentry. Thus the optical system 28 on the input side includes a radiation source 76 and a monochromator 78 for selecting a desired wavelength, with the selected wavelength radiation from the monochromator 78 being suitably directed into each flow cell 16, for example via optical fibres 80 (there being one optical fibre 80 per flow cell 16 plus a reference channel). The detection side of the optical system 28 includes silicon diodes 88 each mounted in line with a respective flow cell 16 and as close as practical to the flow cell 16.

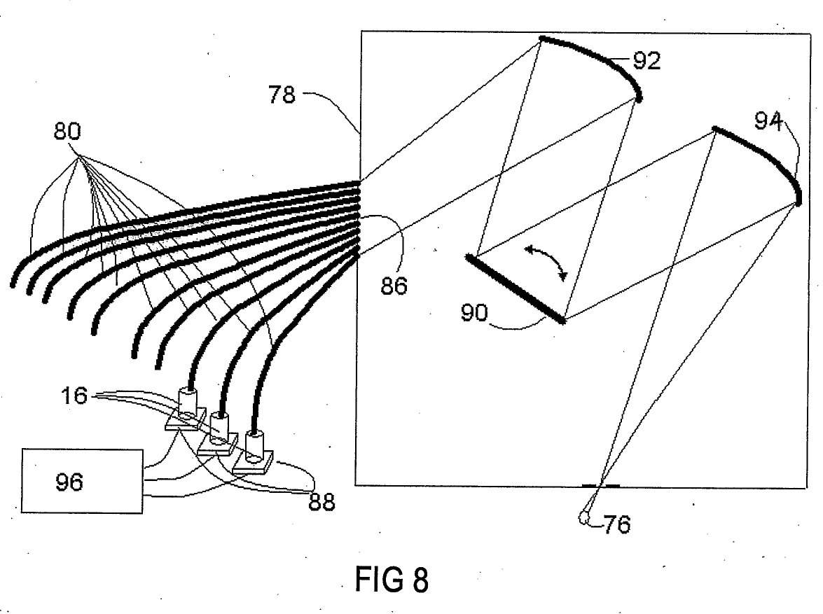

FIG. 8 illustrates the input side optical fibres 80 bundled into the exit slit 86 of the monochromator 78, which includes a diffraction grating 90 and mirrors 92 and 94 in a Czerny-Turner arrangement, as is known. The detector arrangement provides a single detector 88 per channel, for example a silicon diode detector per channel. A single microprocessor system 96 is provided to read the detectors 88 as indicated by reference 82. This system can read all channels effectively simultaneously.

A simpler but more limited optical system which may be adequate for some applications is to dispense with the monochromator 78 and illuminate one side of the flow cells 16 either directly from a narrow band light source such as a mercury vapour lamp (emitting at predominantly 253.7 nm) or to illuminate the flow cells 16 from the lamp via a narrow band filter such as an interference filter.

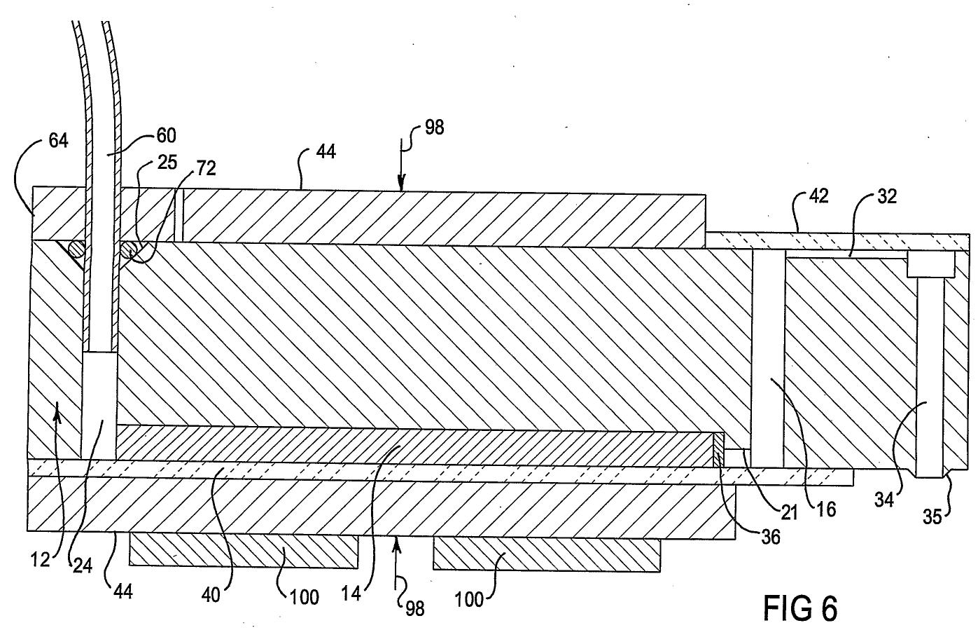

In a multi-column liquid chromatography system 10, the pair of rigid presser plates 44 are components of the analytical instrument whereas the column plate 12 may be a disposable item. The instrument may be arranged such that closure of the sample compartment door following insertion of a column plate 12 (or some other action) will automatically cause the pair of presser plates 44 to clamp the column plate 12 therebetween (see FIG. 6). When the cover sheets 40 and 42 of the column plate 12 are membranes, as described above, the presser plates 44 apply pressure to the column plate 12 (as indicated by arrows 98) for the chromatography columns 14 to remain intact under the pressures applied by the pumping system 46, which are typically high. The presser plates 44 do not need to back-up the membranes 40 and 42 over the flow cells 16 because the liquid in the flow cells 16 is at substantially atmospheric pressure following the stationary phase retaining frit masses 36. The presser plate 44 adjacent the membrane 40 and chromatography columns 14 also includes Peltier heating and cooling devices 100 for heating or cooling that presser plate 44 to control the temperature of the chromatography columns 14, or apply a temperature gradient to them, during a separation as has been described above.

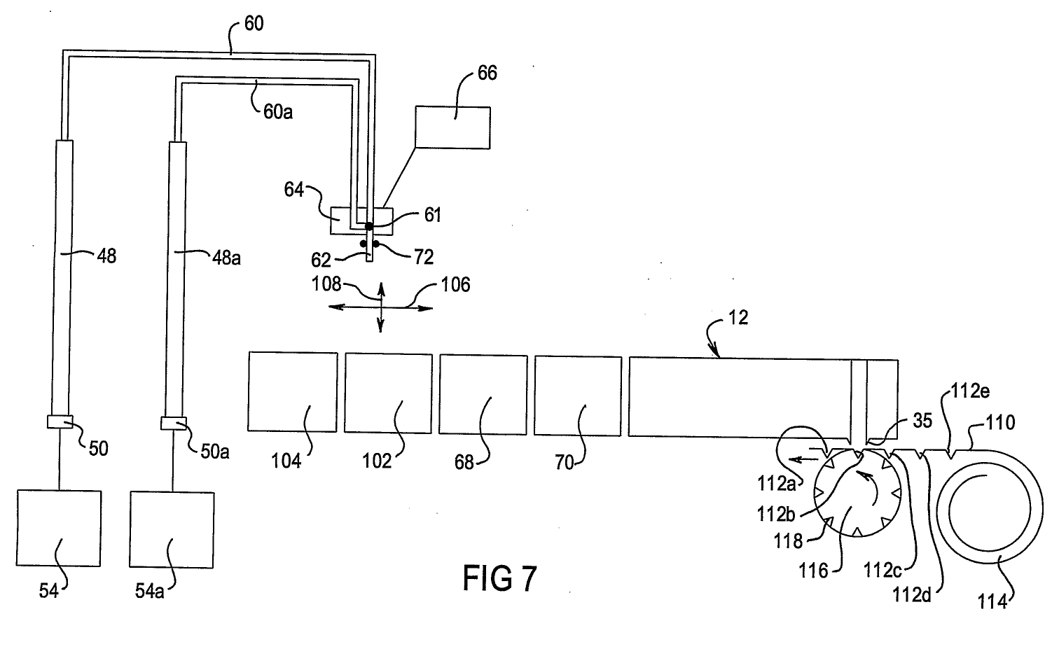

With reference to FIG. 7, an in-line arrangement of the column plate 12, the sample reservoir 70, the mobile phase reservoir 68, a reservoir 102 for another mobile phase (for example water), and a waste trap 104 for waste flow from the pump tubes 60 is shown wherein the sampler controller 66 is required to provide only x and z motion (see arrows 106 and 108 respectively) of the clamp block 64.

FIG. 7 furthermore illustrates a second syringe pump arrangement 48a operated by a second electric motor 54a and having pump tubes 60a which join into, respectively, the pump tubes 60 of the first syringe pump arrangement 48 via a mixing arrangement 61 within the clamp block 64. This is for providing a mobile phase gradient over time within the chromatography columns 14 of the column plate 12. Thus, the sampler controller 66 can be operated to place the free ends 62 of the pump tubes 60 within the mobile phase medium in reservoir 102, and the electric motor 54 operated for the syringe pumps 48 to draw in that mobile phase. The sampler controller 66 is then operated to place the free ends 62 of the pump tubes within the mobile phase medium in reservoir 68, and the electric motor 54a then operated to draw that mobile phase into the syringe pumps 48a. The free ends 62 are then placed within the sample reservoirs 70 and preferably the electric motor 54a (or motor 54) again operated for slugs of the samples to be drawn into the ends 62 of the pump tubes. The last syringe pump arrangement to be operated to draw in mobile phase (that is the arrangement 48a via electric motor 54a in the above description) is preferably operated to draw in the slugs of sample to minimise any inaccuracy in collecting a known sample volume resulting from backlash in the syringe drive mechanism. The next step is for the sampler controller 66 to be operated to place the pump tubes 60 and 60a free ends 62 into the inlets 24 of the chromatography columns 14 and for the seals between O-rings 72 and entrances 25 to be established (see FIG. 5). The motor 54a (or motor 54) is then operated to inject the samples from syringes 48a (or syringes 48) into the columns 14 and then both motors 54 and 54a are variably driven to vary the relative pumping rate of each lot of syringes 48 and 48a progressively during the analysis to establish a desired mobile phase gradient involving the two mobile phases.

FIGS. 1 and 7 both illustrate use of a sample fraction collection sheet 110 that has rows of wells 112a, 112b, 112c, 112d, etc extending across its width, with each well 112 in a row 112a, 112b, etc spaced apart a distance equal to the spacing between the chromatography columns 14 of a column plate 12, and thus of the spacing of outlet through holes 34 and their corresponding outlet nipples 35. The wells 112 also form columns along the length of the fraction collection sheet 110. The fraction collection sheet 110 is flexible such that a substantial length of it is storable on a storage roll 114. In operation, the fraction collection sheet 110 is driven from the storage roll 114 past (and very closely spaced to) the row of flow cell outlet nipples 35 by a driven drum 116 having indentations 118 in its surface for engaging the wells 112 in the fraction collection sheet 110. The drum 116 is driven, possibly in response to the optical system 28 detection of fraction peaks, to locate a row of wells (112b in FIGS. 1 and 7) under the row of nipples 35 for the sample fractions corresponding to that peak to collect within the wells 112 via the outlet nipples 35. The drum 116 is then again driven to position the next row of wells 112c under the nipples 35 for the next sample fractions to be collected. The close spacing of the sheet 110 below the nipples 35 is such that any remaining droplets on the nipples 35 will be wiped off into the wells 112b as the sheet 110 is moved.

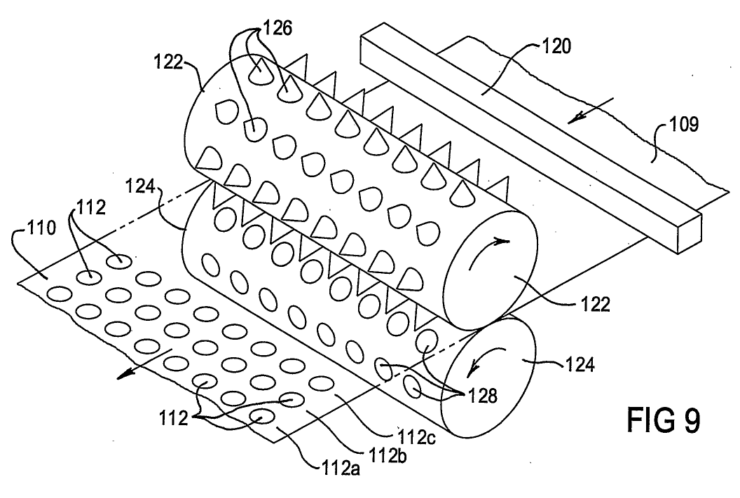

With reference to FIG. 9, the sample fraction collection sheet 110 is formed from an indefinite length of a flexible plastic sheet 109, for example of polypropylene 300 micron thick. Other deformable materials and sheet thicknesses are also practical. This flexible plastic sheet is fed past a heater 120 to the nip between two driven counter-rotatable rolls 122 and 124. One roll 122 includes protrusions 126 and the other roll includes cavities 128 within which the protrusions 126 are received as the rolls 122, 124 rotate. The flexible plastic sheet 109 is heated sufficiently by heater 120 as to be deformable between the protrusions 126 and cavities 128 as the sheet 109 passes between the rolls 122, 124 thereby forming the rows and columns of wells 112. The flexible sheet containing the wells 112 that emerges from the rolls 122, 124 comprises the sample fraction collection sheet 110 and can be fed from the rolls 122, 124 to be stored on a roll 114 for use in a multi-column liquid chromatography system 10 as described above with reference to FIG. 1.

For applications where sample fraction collection is not required, the moulded plate 18 need not have the nipples 35.

Example dimensions for components of the multi-column liquid chromatography system 10 are:

Columns 14, twelve (12) or twenty four (24) columns, each column cross-sectional area 2 sq·mm, (eg groove 20: 2 mm wide×1 mm deep; groove 21: 0.05 mm wide×0.05 mm deep), each column length 5 cms.

Capacity of a syringe pump 48 of the syringe pumping system 46, 1 ml to 1.5 ml Flow cell 16 dimensions, 0.7 mm diameter, 3 mm long (about 1.2 μl)

Detector arrangement 88, wavelength range 210 mm to 600 mm (lower limit set by cover sheets 40 and 42 transparency)

Operating parameters, sample volume 3 μl, mobile phase pumping rate 100 μl/min.

Typical mobile phases are water, methanol, or acetonitrile. Many stationary phases are possible for example silica with an appropriate surface coating such as octadecylsiloxane (“C18”). For another example divinylbenzene polymer can be used for DNA or protein separations. In essence, the disclosed system is suitable for use with any stationary phase material that can be used in conventional chromatography.

The invention described herein is susceptible to variations, modifications and/or additions other than those specifically described and it is to be understood that the invention includes all such variations, modifications and/or additions which fall within the scope of the following claims.

1. Apparatus for liquid chromatography comprising:
a column plate structure that provides a plurality of liquid chromatography columns for performing a plurality of chromatography separations in parallel comprising a plate having grooves formed in a surface, a cover sheet bonded to said surface to cover the grooves, and a stationary phase for each liquid chromatography column is contained in each covered groove.

2. Apparatus as claimed in claim 1 wherein the column plate structure further provides a flow cell at an outlet of each said chromatography column, the flow cells being provided by through holes in the plate and said cover sheet providing an end wall for each flow cell, a second cover sheet, which is bonded to a surface of the plate opposite the grooved surface and provides an opposite end wall for each said flow cell,
wherein said cover sheets are transparent to radiation of selected wavelengths.

3. Apparatus as claimed in claim 2 comprising a pair of presser plates for receiving therebetween the column plate structure and for applying pressure to the column plate structure for the liquid chromatography columns to remain intact under operating pressures.

4. Apparatus as claimed in claim 3 further comprising a heater that is associated with the presser plate of the pair of presser plates, which engages the cover sheet covering the grooves of the plate whereby said presser plate is located adjacent to the plurality of liquid chromatography columns and the heater is operable for controlling the temperature of the chromatography columns during a separation.

5. Apparatus as claimed in claim 1 further comprising a pumping system for simultaneously supplying a sample or a mobile phase into an inlet, respectively, of each said chromatography column.

6. Apparatus as claimed in claim 5 wherein the pumping system comprises a plurality of syringe pumps, one for each said chromatography column, and wherein the pumping system comprises a control mechanism that is common to the plurality of syringe pumps for the syringe pumps to provide a substantially identical positive displacement flow of the mobile phase through each said chromatography column.

7. Apparatus as claimed in claim 6 wherein the plurality of syringe pumps is provided via a syringe block containing a plurality of bores, each bore containing a piston and the pistons connected together by a common gantry for the syringe pumps to provide the substantially identical positive displacement flow.

8. Apparatus as claimed in claim 6 wherein the plurality of syringe pumps of said plurality are mounted together, each syringe pump having a piston wherein the pistons are mechanically coupled such that they are operable together.

9. Apparatus as claimed in claim 6 wherein a pump tube extends from an outlet of each said syringe pump and each said pump tube has a free end, and comprising a clamp block, which holds each said pump tube near its free end such that the free ends of the pump tubes are maintained in predetermined spaced apart relationship corresponding to the spacing of the inlets of the plurality of chromatography columns.

10. Apparatus as claimed in claim 9 further comprising a controller for moving the clamp block and thus the free ends of the pump tubes to different locations, wherein each said pump tube includes a seal adjacent its free end, and wherein the controller is operable to move the clamp block for the free ends of the pump tubes to sealingly engage the inlets of the chromatography columns.

11. Apparatus as claimed in claim 10 wherein the pumping system comprises an additional plurality of syringe pumps, one for each chromatography column, and an additional control mechanism that is common to the additional plurality of syringe pumps to provide simultaneously a substantially identical positive displacement flow of an additional mobile phase through each said chromatography column, the additional syringe pumps each having a pump tube that extends from an outlet of each syringe pump, wherein the pump tubes of the additional syringe pumps are connected into the pump tubes of the first defined plurality of syringe pumps, whereby the first defined and the additional pluralities of syringe pumps are differentially operable for varying a composition of the mobile phase over time during an analysis.

12. Apparatus as claimed in claim 2 further comprising an optical system for transmitting radiation through each said flow cell and comprising a detection arrangement for detecting radiation from each said flow cell.

13. Apparatus as claimed in claim 12 wherein the optical system comprises a monochromator for deriving a beam of substantially monochromatic radiation from a single source for transmission through each said flow cell, wherein the optical system comprises optical fibres for directing the monochromatic radiation from the monochromator simultaneously into each said flow cell, and wherein the detection arrangement comprises individual light detectors respectively positioned closely adjacent to and in line with the respective flow cells.

14. Apparatus as claimed in claim 2 wherein the column plate structure defines an outlet from each said flow cell, the liquid chromatography apparatus further comprising a sample fraction collection sheet containing wells in rows and columns, wherein the wells in a row are spaced apart a distance equal to a spacing of the outlets from the flow cells and the sample fraction collection sheet is locatable relatively to the column plate structure for sample fractions to discharge from the outlets of the flow cells directly into the wells.

15. Apparatus as claimed in claim 14 wherein the sample fraction collection sheet is flexible whereby a length thereof is storable on a roll for feeding from the roll past the Outlets from the flow cells of the column plate structure.

16. A plate for a multi-column structure for liquid chromatography comprising:
a plurality of first grooves in a surface thereof for each first groove to form a column for liquid chromatography when a cover sheet is bonded to the surface of the plate over the first grooves and each first groove is filled with a stationary phase,
the plate comprising through holes each associated with one end of each first groove to provide an inlet into each said chromatography column, the plate furthermore including, at the other end of each first groove, a second groove leading from the first groove to provide an outlet path from each said chromatography column wherein the second grooves are smaller in cross-sectional size than the first grooves,
the plate comprising further through holes each associated with an end of each second groove for providing a flow cell in the outlet path from each said chromatography column.

17. The plate as claimed in claim 16 comprising a cover sheet bonded to the surface of the plate containing the first grooves to cover the first grooves, wherein the first grooves are each filled with a stationary phase thereby providing a plurality of columns for liquid chromatography, and wherein each second groove leading from each first groove defines a size transition volume and particles of a stationary phase are wedged into each size transition volume to provide a porous barrier for retaining the stationary phase.

18. The plate as claimed in claim 16 comprising a first cover sheet bonded to the surface containing the first grooves to cover the first grooves and the further through holes, and a second cover sheet bonded to a surface of the plate opposite the grooved surface to cover the further through holes, whereby the first and the second cover sheets provide end walls for each said flow cell, wherein the first and second cover sheets are transparent to analytical radiation of selected wavelengths.

19. The plate as claimed in claim 18 wherein each said second groove leading from each said first groove defines a size transition volume and particles of a stationary phase are wedged into each size transition volume to provide a porous barrier for retaining the stationary phase

20. A method for liquid chromatography comprising:
providing a plurality of liquid chromatography columns,
providing a syringe pump for each said column, each said syringe pump having a pump tube having an open end,
simultaneously placing the open ends of the pump tubes into a mobile phase reservoir,
simultaneously operating the syringe pumps to draw a volume of the mobile phase into each said pump tube,
withdrawing the pump tubes from the mobile phase reservoir and then simultaneously placing each said open end of each said pump tube into a respective sample reservoir,
simultaneously operating the syringe pumps to draw a volume of sample into each pump tube,
withdrawing the pump tubes from the sample reservoirs and then simultaneously applying each said open end of each said pump tube to a respective inlet of each said chromatography column, and
simultaneously operating the syringe pumps to pump the sample and the mobile phase from each said syringe pump through each said respective chromatography column.
